(19) United States
(12) Patent Application Publication
(10) Pub. No.: US 2023/0336509 A1
(43) Pub. Date: Oct. 19, 2023

(54) EFFICIENTLY HANDLING RETAINED MESSAGES IN A SYSTEM WITH BRIDGED MESSAGE BROKERS

(71) Applicant: Microsoft Technology Licensing, LLC, Redmond, WA (US)

(72) Inventors: Peter Gregg MILLER, Seattle, WA (US); David Michael SAUNTRY, Redmond, WA (US); Kevin Thomas DAMOUR, Redmond, WA (US); Bhawandeep Singh PANESAR, Bellevue, WA (US); Dmitri Alexandrovich KLEMENTIEV, Redmond, WA (US)

(21) Appl. No.: 17/828,723

(22) Filed: May 31, 2022

Related U.S. Application Data
(60) Provisional application No. 63/331,000, filed on Apr. 14, 2022.

(51) Int. Cl. H04L 51/212

(52) U.S. Cl. CPC H04L 51/212

(57) ABSTRACT

Methods, systems, apparatuses, and computer-readable storage mediums are described for handing retained messages among brokers of Internet of Things (IoT) messages. In an example system, a retained message coordinator of a first message broker receives an indication of a subscription specifying a topic filter from an IoT device. The retained message coordinator identifies, from a data structure shared by a second message broker, a retained message set for a topic within a scope of the topic filter. The retained message coordinator retrieves the retained message set from a shared data store, and provides the retained message set to the IoT device.

### CROSS-REFERENCE TO RELATED APPLICATIONS

This application claims priority to provisional U.S. Patent Application No. 63/331,000, filed Apr. 14, 2022, entitled “Efficiently Handling Retained Messages in a System with Bridged Message Brokers,” the entirety of which is incorporated by reference herein.

### BACKGROUND

In certain types of messaging environments, client devices can operate as a publisher or a subscriber, or both, of messages of a given topic or multiple topics. In such environments, a client device sending a message (e.g., a publisher) publishes a message to a topic. The message is received by a message broker responsible for determining which subscribers should receive the message and routing the message to those subscribers. In this manner, once a publisher publishes a message to the topic, subscribers of a topic filter that includes that topic receive the message through the broker.

In these messaging environments, client devices communicate with a single message broker. When the number of client devices or messages increases beyond the capabilities of a single message broker, multiple message brokers may be bridged together to handle the additional load. In some messaging environments, a message from a publisher can be marked for retaining, which causes the message broker connected to the publisher to retain the most recent copy of a message on a given topic. A retained message may then be delivered to any future clients that connect to the broker and subscribe to receiving messages for a topic filter that matches the given topic.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer-readable storage mediums are described for handing retained messages among brokers of Internet of Things (IoT) messages. In an example system, a retained message coordinator of a first message broker receives an indication of a subscription specifying a topic filter from an IoT device. The retained message coordinator identifies, from a data structure shared by a second message broker, a retained message set for a topic within a scope of the topic filter. The retained message coordinator retrieves the retained message set from a shared data store, and provides the retained message set to the IoT device.

Further features and advantages of embodiments, as well as the structure and operation of various embodiments, are described in detail below with reference to the accompanying drawings. It is noted that the methods and systems are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example system for handing retained messages among bridged message brokers, in accordance with an example embodiment.

FIG. 2 shows a flowchart of a method for handling retained messages among message brokers, in accordance with an example embodiment.

FIG. 3 shows a flowchart of a method for storing retained messages in a shared data store, in accordance with an example embodiment.

FIG. 4 shows a flowchart of a method for retrieving a retained message set from a shared data store, in accordance with an example embodiment.

FIG. 5 shows a flowchart of a method for matching a topic to a topic filter, in accordance with an example embodiment.

FIG. 6 shows a flowchart of a method for sharing a list of topics that contain retained messages with another message broker, in accordance with an example embodiment.

FIG. 7 is a block diagram of an example processor-based computer system that may be used to implement various embodiments.

The features and advantages of the embodiments described herein will become more apparent from the detailed description set forth below when taken in conjunction with the drawings. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

In certain types of messaging environments, client devices can be a publisher or a subscriber, or both, of messages of a given topic or multiple topics. In such environments, a client device sending a message (e.g., a publisher) publishes a message to a topic. The message is received by a message broker responsible for determining which subscribers should receive the message and routing the message to those subscribers. In this manner, once a publisher publishes a message to the topic, subscribers of a topic filter that includes that topic receive the message through the broker.

In these messaging environments, client devices communicate with a single message broker. When the number of client devices or messages increases beyond the capabilities of a single message broker, multiple message brokers may be bridged together to handle the additional load. In some messaging environments, a message from a publisher can be marked for retaining, which causes the message broker connected to the publisher to retain the most recent copy of a message on a given topic. A retained message may then be delivered to any future clients that connect to the broker and subscribe to receiving messages for a topic filter that matches the given topic. As each message broker is typically responsible for storing retained messages, a system with bridged message brokers raises challenges in ensuring that a client coupled to one message broker is able to receive the most recently retained message across all the message brokers on a given topic.

Embodiments described herein address these issues in numerous ways. In an example system, a retained message coordinator of a first message broker receives an indication of a subscription specifying a topic filter from an IoT device. The retained message coordinator identifies, from a data structure shared by a second message broker, a retained message set for a topic within a scope of the topic filter. The retained message coordinator retrieves the retained message set from a shared data store, and provides the retained message set to the IoT device.

Handling retained messages among bridged message brokers as described herein has numerous advantages, including but not limited to improving the utilization of resources (e.g., computing, memory, and/or network resources) of computing devices. For instance, in accordance with disclosed techniques, each message broker in the bridged set of brokers may readily identify, using a shared data structure and shared data store, which retained messages should be provided to clients with new subscriptions. Rather than brokers sharing all of their respective messages with other brokers and requiring each individual broker be responsible for separately identifying which message is the most recent message across all the brokers, the shared data store as disclosed herein allows for brokers to identify and retrieve retained messages in an efficient manner. Such techniques may allow for a reduction in processing resources (e.g., by reducing the processing burden on a given broker in identifying the latest retained message that may have been received by a separate broker), memory resources (e.g., by avoiding the need for each message broker to store all retained messages across all the bridged brokers), and networking resources (e.g., by reducing the unnecessary transmission of messages over a network). As a result, improvements with respect to computing resources may be achieved in various respects in accordance with the disclosed techniques.

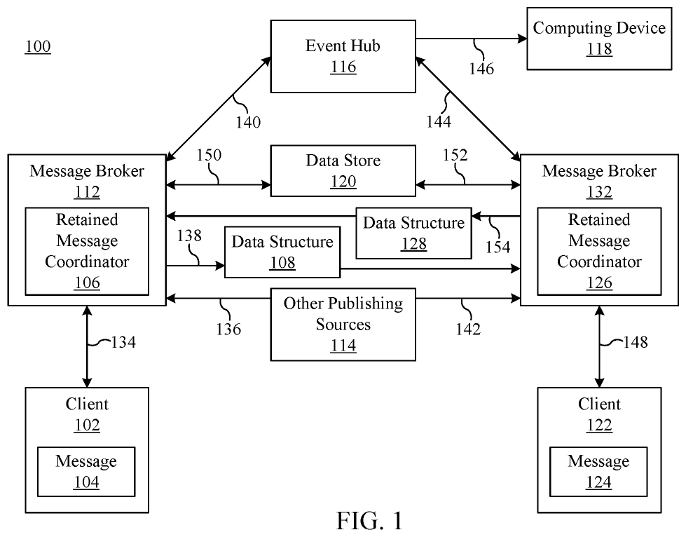

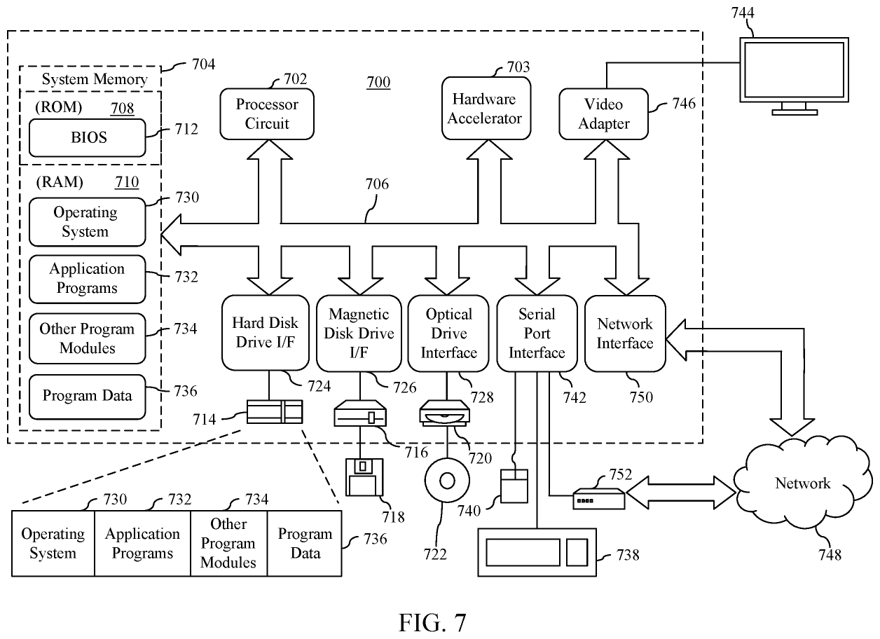

As such, example embodiments are described herein directed to techniques for handling retained messages among bridged message brokers. For instance, FIG. 1 shows a block diagram of an example system for handling retained messages among bridged message brokers, in accordance with an example embodiment. As shown in FIG. 1, system 100 includes a client 102, a data structure 108, a message broker 112, other publishing sources 114, an event hub 116, a computing device 118, a data store 120, a client 122, a data structure 128, and a message broker 132. Client 102 includes a message 104. Message broker 112 includes a retained message coordinator 106. Message broker 132 includes a retained message coordinator 126. Client 122 includes a message 124. Client 102, message broker 112, other publishing sources 114, event hub 116, computing device 118, client 122, and message broker 132 may be communicatively coupled by one or more networks or peer-to-peer connections (not shown). An example computing device that may incorporate the functionality of one or more of client 102, message broker 112, other publishing sources 114, event hub 116, computing device 118, client 122, and message broker 132 (or any subcomponents therein, whether or not illustrated in FIG. 1) is described below in reference to FIG. 7. System 100 may comprise any number of devices, including those illustrated in FIG. 1 and optionally one or more further devices or components not expressly illustrated. System 100 is further described as follows.

A network that couples any of the components shown in FIG. 1 may include one or more of a local area network (LAN), a wide area network (WAN), a personal area network (PAN), a combination of communication networks, such as the Internet, and/or a virtual network. In example implementations, client 102, message broker 112, other publishing sources 114, event hub 116, computing device 118, client 122, and message broker 132 communicate via the network. In an implementation, any one or more of client 102, message broker 112, other publishing sources 114, event hub 116, computing device 118, client 122, and message broker 132 may communicate over the network via one or more application programming interfaces (API) and/or according to other interfaces and/or techniques. Client 102, message broker 112, other publishing sources 114, event hub 116, computing device 118, client 122, and message broker 132 may each include at least one network interface that enables communications with each other. Examples of such a network interface, wired or wireless, include an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. In some other examples, any one or more of client 102, message broker 112, other publishing sources 114, event hub 116, computing device 118, client 122, and/or message broker 132 (or subcomponents therein) may be coupled by one or more peer-to-peer connections that enables wired and/or wireless communications with each other. Further examples of network interfaces are described elsewhere herein.

Client 102 may include one or more computing devices of one or more users (e.g., individual users, family users, enterprise users, governmental users, etc.) that each comprise one or more applications, operating systems, virtual machines, storage devices, etc. that may transmit and/or receive message 104. Client 102 may be any type of stationary or mobile device, such as an Internet of Things (IoT) device. As used herein, an IoT device comprises any computing device that may connect to another computing device or system via a connection to a network (e.g., the Internet) or a peer-to-peer connection to send and receive (e.g., exchange) data. In some implementations, an IoT device includes one or more physical networking components for wirelessly connecting to the Internet for sending and receiving data (e.g., messages). Examples of client 102 include a vehicle (e.g., an electric vehicle) comprising computing functionality, a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone (e.g., a cell phone, a smart phone such as an Apple iPhone, a phone implementing the Google® Android™ operating system, a Microsoft Windows® phone, etc.), a wearable computing device (e.g., a head-mounted device including smart glasses such as Google® Glass™, Oculus Rift® by Oculus VR, LLC, etc.), a camera, a sensor, a home assistant device, a smart home device, an appliance, or other type of stationary or mobile device. Client 102 is not limited to a physical machine, but may include other types of machines or nodes, such as a virtual machine. In some implementations, client 102 may comprise one or more sensors for capturing information in or around client 102, including but not limited to a temperature sensor, a pressure sensor, an accelerometer, a gyroscope, an orientation sensor, an image sensor, a biometric sensor, or a global positioning system (GPS) sensor. Client 102 may interface with other components illustrated in FIG. 1 through APIs and/or by other mechanisms.

Message 104 includes any set of information that is generated at client 102 for transmission 134 to another entity (e.g., message broker 112) or information that is generated outside of client 102 (e.g., received 136 from other publishing sources 114 or client 122 via message broker 132, or similarity, received 142 by message broker 132 from other publishing sources 114) for transmission 134 to client 102. In some implementations, message 104 may include a publish or a subscribe message in a publish-subscribe messaging environment. For instance, message 104 generated at client 102 (e.g., a publish message) may include information relating to conditions local to client 102 (e.g., a condition, such as a weather condition, based on sensor data at client 102). In other examples, message 104 generated outside of client 102 may include any information relating to a topic filter to which client 102 has subscribed, such as alerts relating to an environment in which client 102 is present (e.g., weather alerts). Message 104 may be associated with a message topic (e.g., a topic may be embedded within or along with message 104). The topic may correspond to a grouping of similar types of message (e.g., similar in content, publishing source, location data, associated user, etc.). In examples, messages received by client 102 may be generated by any device, including but not limited to other clients, other publishing sources 114 (which may include any external device or service that generates a messages), client 122, or any other device or service not expressly illustrated in FIG. 1. These examples are only illustrative, and message 104 may include any type of information generated by client 102 and/or by other publishing sources.

Message 104 may also be transmitted to or from client 102 along with a particular message topic associated therewith and/or a retaining indication (e.g., a flag or other marker) indicating that message 104 should be retained. In some implementations, the retaining indication includes an expiration date or a Time-to-Live (TTL) lifespan that indicates a maximum amount of time the message should be retained before being discarded by a message broker.

Client 122 and message 124 is similar to client 102 and message 104, respectively. As shown in FIG. 1, client 102 is communicatively coupled to a first message broker (message broker 112), while client 122 is communicatively coupled to a second message broker (message broker 132). For instance, where client 102 seeks to publish message 104, client 102 will send message 104 to message broker 112 to which it is coupled, and message broker 112 (as described in further detail below) will manage the routing (e.g., distribution) of the message. Similarly, where client 122 seeks to publish message 124, client 122 will send message 124 to message broker 132 to which it is coupled, and message broker 132 will manage the routing (e.g., distribution) of the message. A similar distribution of messages may also occur in subscribe scenarios. For instance, where message 104 has an associated topic that matches a topic filter to which client 102 has subscribed, message broker 112 will transmit the message to client 102. Similarly, where message 124 has an associated topic that matches a topic filter to which client 122 has subscribed, message broker 132 will transmit 148 the message to client 122.

In some implementations, any of the message brokers described herein may be implemented in an edge device (e.g., a vehicle) configured to broker messages to and from components within the edge device (e.g., messaging devices within the vehicle itself that are coupled to the message broker of the vehicle). In other words, such an edge device may comprise a message broker that is configured to broker messages between messaging devices coupled to this message broker (e.g., intra-module communications) and to broker messages to and from other messages brokers (e.g., brokers on the cloud). In such instances, due to the limited resources of such a message broker implemented in an edge device, efficient bridging of messages from other message brokers may be desired (e.g., by only transmitting messages (e.g., retained messages) to the message broker in the edge device that the edge device actually needs based on its subscribers).

In implementations, message broker 112 may not directly send a message to client 122, and message broker 132 may not directly send a message to client 102 due to client 102 not being coupled to message broker 132, and client 122 not being coupled to message broker 112. For similar reasons, client 102 may not directly transmit a message to message broker 132 for publishing, and client 122 may not directly send a message to message broker 112 for publishing. Message broker 112 and/or message broker 132 may each comprise a component (not shown) for coordinating the bridging of the message brokers, such that messages may be distributed across message brokers.

Message broker 112 comprises a device or service for distributing messages between publishers and subscribers. For instance, a message broker as used herein refers to an entity for receiving a message from one device (e.g., an IoT device) or service, and distributing the message to one or more endpoints, which can include one or more subscribers in accordance with the subscribers' subscriptions and/or one or more locations to which the message is published.

In examples, message broker 112 may be configured to receive at least message 104 and/or a topic associated with message 104 (e.g., from client 102 or any other publishing source coupled to message broker 112), and/or a retaining indication associated with message 104. In examples, message broker 112 determines whether message 104 is allowed to be published to the topic associated with the message. If message broker 112 determines that message 104 is allowed to be published, message broker 112 processes the message. If message broker 112 determines that message 104 is not allowed to be published, message broker 112 rejects the message for publishing to the designated topic.

While the above example is described with respect to publishing message 104 received from client 102, similar techniques may be employed for messages to which client 102 has subscribed. For instance, when a message arrives at message broker 112 for a given topic, message broker 112 may determine whether client 102 has subscribed to receiving messages for a topic filter (that may include one or more wildcards) that matches the topic associated with message 104. If client 102 has subscribed to messages for a topic filter that matches the associated topic, message broker 112 may cause the message to be transmitted to client 102.

In some implementations, message broker 112 may determine, based on the retaining indication, whether message 104 should be retained. In examples, a retained message is a message that is stored in a location accessible and/or managed by a message broker (e.g., message broker 112) until a new message for the same topic is received or until a determination is made that the message should be discarded (e.g., based on an expiration). In other words, the retained message comprises the most recent message published to a given message topic that is designated for retaining. When a client subscribes to receiving messages published to a message topic (or a plurality of message topics) of which the client was not previously subscribed, the message broker coupled to the client may transmit, to the client, any retained messages corresponding to the client's subscriptions. In this manner, the client may be provided with the most recent message on a topic that was published prior to their subscription being initiated. As will be described in greater detail below, retained message coordinator 106 and retained message coordinator 126 may be configured to coordinate the retaining of messages across different message brokers, such that when a client coupled to a first message broker subscribes to receiving messages published to new topic, the first message broker may identify a retained message for that topic received by second message broker for transmission to the client.

Message broker 132 is similar to message broker 112. For instance, message broker 132 may receive a message and/or an associated topic from client 122 or another publishing source, and determine whether the message may be published or transmitted to a subscriber in a similar manner. In some implementations, message broker 112 and message broker 132 form a bridged set of message brokers, where the bridged set of message brokers may operate in conjunction to distribute messages across various components of system 100. Message broker 112 and message broker 132 may be operated by a single entity, comprise the same functionalities or designs, and/or implement the same protocol (or version thereof). In some other implementations, message broker 112 and message broker 132 may be operated by different entities, may comprise different functionalities or designs, and/or implement different protocols (or versions thereof). While two bridged message brokers (message broker 112 and message broker 132) are described for illustrative purposes, any number of messages brokers may be bridged together to form a bridged set of message brokers in accordance with the disclosed techniques. For instance, each message broker in the bridged set may similarly comprise a retained message coordinator and may comprise any number of client devices that may provide messages to, or receive messages from, the broker to which they are coupled. Further details and examples regarding the operation of message broker 112 and message broker 132 will be discussed below.

Retained message coordinator 106 and retained message coordinator 126 may be configured to coordinate the manner in which retain messages are handled across message broker 112 and message broker 132. In implementations, retained message coordinator 106 and retained message coordinator 126 may operate by enabling message broker 112 and message broker 132 that are bridged together to share a common set of retained messages, such that a client coupled to either message broker may be provided with the most recent message on a topic (i.e., a retained message for the topic), even if the retained message was initially published by a different message broker. Retained message coordinator 106 and retained message coordinator 126 may each access a shared data structure that identifies, for each of a plurality of topics, a corresponding retained message. Data structure 108 is an example of a data structure built and shared 138 by retained message coordinator 106, and data structure 128 is an example of a data structure built and shared 154 by retained message coordinator 126 in accordance with disclosed techniques.

For any topic for which a retained message is present, the message broker may access 150, 152 data store 120 shared across the message brokers (e.g., accessible by retained message coordinator 106 and retrained message coordinator 126) to obtain the retained message to provide to client that has newly subscribed to receiving messages for a topic filter that includes the topic. Additional details and examples regarding the operation of retained message broker 106 and retained message broker 126 will be described in greater detail below. It is noted that retained message coordinator 106 and retained message coordinator 126 need not be implemented within message broker 112 and message broker 132, respectively. Rather, in some other implementations, retained message coordinator 106 and retained message coordinator 126 may be implemented, in whole or in part, as part of other devices or services (e.g., a wrapper in communication with each respective broker) or as standalone components.

In some implementations, message broker 112 and/or message broker 132 may publish 140, 144 one or more messages to event hub 116. It is noted that publishing the message(s) to event hub 116 may comprise any suitable technique for providing or otherwise transmitting the message(s) to event hub 116 and is not limited to publishing a message as that term is used herein. Event hub 116 may comprise a data ingestion service configured to receive messages (and/or any other information) and transmit 146 one or more of such messages to other devices, including client 102, client 122, and/or computing device 118. Computing device 118 may be any type of stationary or mobile device, similar to client 102 or client 122 as described above. For instance, computing device 118 may be configured to receive a message generated local to a client device (e.g., an alert generated at client 102 or client 122). While a single event hub is illustrated in FIG. 1, implementations may comprise any number of event hubs. For instance, each message broker shown in FIG. 1 may utilize a different instance of an event hub for publishing messages.

Implementations are not limited to the illustrative arrangement shown in FIG. 1. For instance, client 102, message broker 112, other publishing sources 114, event hub 116, computing device 118, data store 120, client 122, and message broker 132 may not be separate or remotely located from each other. In some examples, any one or more of client 102, message broker 112, other publishing sources 114, event hub 116, computing device 118, data store 120, client 122, and message broker 132 (or any subcomponents therein) may be part of or accessible via the same computing device or distributed across a plurality of devices. For instance, a client device (e.g., client 102 or client 122) may comprise a message broker (e.g., message broker 112 or message broker 132) configured to broker messages to different modules, processes, or services local to the client, as well as messages to and from the cloud (e.g., by bridging to another broker, as described herein). Furthermore, it is understood that each of the components illustrated in FIG. 1 need not be present in all implementations. Message broker 112 and/or message broker 132 may also publish messages directly to one or more other devices without event hub 116. System 100 may also comprise any number of additional devices not shown in FIG. 1 that may be coupled in any manner in accordance with the disclosed techniques.

The following description is intended to further describe the above example embodiments and describe additional example embodiments in which implementations may be provided. Furthermore, the description that follows explains additional context for such example embodiments and details relating to the implementations. This description is intended to illustrate various aspects and/or benefits that may be achieved based on techniques described herein and are not intended to be limiting. Accordingly, while additional example embodiments are described, the features described below are not required in all implementations.

In example embodiments, techniques may be implemented by or in one or more of client 102, message broker 112, other publishing sources 114, event hub 116, computing device 118, client 122, and message broker 132 (or any of their subcomponents). While certain examples are described below with respect to retained message coordinator 106 and/or message broker 112, such illustrations are provided for brevity, and similar techniques may be carried out by retained message coordinator 126 and/or message broker 132 (and vice versa). Other structural and operational implementations will be apparent to persons skilled in the relevant art(s) based on the following discussion.

The Message Queueing Telemetry Transport (MQTT) protocol specification is a publish/subscribe (also referred to as a pub/sub) protocol on which messages may be published to a specific topic. In example embodiments, message brokers (e.g., pub/sub brokers) operate by decoupling publishers (the sender of a message) and subscribers (the receiver of a message), with publishers publishing to a “topic” and subscribers subscribing to a “topic filter.” A single client (e.g., client 102) may be both publisher and subscriber for many topics and topic filters. Topics may comprise any suitable structure or format. In one example, a topic may comprise segments (e.g., strings) separated by ‘/’ characters. Topic filters are similar to topics, but also may contain one or more wildcard characters. Specific wildcard characters used in a given environment may depend on the particular pub/sub protocol used. In one implementation, wildcard characters may be based on an MQTT protocol, in which a ‘+’ character represents a single-segment wildcard and a ‘#’ character represents a full-topic wildcard, which will match any number of segments but appears last in the topic filter. Topics, however, may not contain wildcard characters, while topic filters can contain wildcard characters. As a result, a publish action cannot use wildcards, whereas a subscribe action can use wildcards. While example implementations are described in which a client's subscription includes a topic filter (which may contain a wildcard), such a subscription need not contain any wildcard characters. Rather, such a subscription may also include subscribing to a topic filter without the use of any wildcards. As used herein, subscribing to a topic filter refers to subscribing to receiving messages for a topic that matches a topic filter specified by a subscription.

As part of the publishing, the publisher (e.g., a client device) can indicate that a message corresponding to a particular topic should be “retained.” A message may be marked or designated by a client as a retained message automatically, manually, or in accordance with any other approach as appreciated by those skilled in the art. As discussed earlier, a retained message is stored by a message broker (e.g., message broker 112) such that any future clients that connect to the message broker and subscribe to a topic filter that includes the particular topic will be sent the most recent retained message published to the topic. In other words, if a client that was previously not subscribed to a topic filter that includes the topic later subscribes to that topic filter, the message broker may provide, to the client, a retained message that was published prior to the client's subscription to the topic filter. In examples, only the most recent message for a specific topic is retained, though many messages can be retained across many topics. In some other examples, a plurality of messages (e.g., the most recent n messages, where n is an integer greater than one) may be retained for a particular topic. While techniques described herein refer to, among other things, storing, identifying, and/or retrieving a retained message, the disclosed techniques may apply to a set of retained messages, where the set of retained messages includes one or more of the most recent messages published to a topic.

In implementations, multiple message brokers (e.g., message broker 112 and message broker 132) may be bridged together to form a set of bridged message brokers. Each broker in a set of bridged brokers may comprise a single logical broker. Such a broker may comprise a service on the cloud and/or may be distributed across many different physical computing devices or virtual machines. While each individual broker may comprise a single endpoint, brokers bridged together may comprise a plurality of endpoints, each associated with a different broker in the set of bridged brokers. Brokers may be bridged together to form a set of bridged brokers for various reasons, including but not limited to scalability, geography, partitioning, etc. As described herein, however, a given client may be coupled to a single broker. As a result, that client may only publish or receive messages processed by that broker. In order for the broker to publish to locations or devices coupled to another broker or receive messages from another broker, messages are transferred across brokers. When message brokers (e.g., MQTT brokers) are bridged together, the bridged message brokers share published messages with each other such that a client coupled to one broker may receive messages published to an entirely different broker. Various techniques may be utilized for this bridging message brokers together. While examples are described herein with respect to MQTT message brokers and MQTT protocols, these examples are illustrative only, and techniques may be implemented in accordance with other interfaces and/or protocols as appreciated by those skilled in the art.

As message brokers are typically responsible for storing a retained message, a system with distributed message brokers that are bridged together renders it difficult to ensure that a client connected to one message broker receives the most recently retained message on a topic, since the most recently retained message may have been published using a different broker. An additional complexity is data ordering and consistency, in which retained messages for the same topic arrive at different bridged brokers. In such a situation, it is expected that bridged brokers have a consistent understanding of which one should be identified and stored as the retained message. Techniques disclosed herein provide for efficient approaches to address these challenges and ensure that retained messages may be properly identified and provided to clients, irrespective of the broker to which the client is coupled.

Mechanisms are described to store and efficiently retrieve a set of relevant retained messages for a topic. In an example implementation, data store 120 is built that is shared and/or accessible by each of a plurality of bridged message brokers. In examples, data store 120 is configured to store retained messages published by a plurality of message brokers across a plurality of topics. In some implementations, data store 120 may comprise any suitable storage mechanism, including but not limited to a database. Data store 120 may be located local to a message broker, distributed across the message brokers, implemented in the cloud, or implemented in any other manner as appreciated by those skilled in the art. In implementations, data store 120 may implement and/or support one or more consistency mechanisms (e.g., a last-write-wins pattern in which the most recent write to data store 120 may overwrite a previous write).

In some implementations, it may be desired to guarantee a strict retain message ordering per a specification (e.g., the MQTT protocol specification). In such a scenario, data store 120 may also be configured to guarantee a strong consistency on any read. For instance, if a write is successfully performed to data store 120, then data store 120 may be configured to guarantee that any subsequent read will return a consistent result (i.e., a stale value would not be returned). The need for strong consistency is not required in all implementations, however, and it is understood that some implementations need not provide for strong consistency (e.g., depending on the needs and/or desires of the customers).

Message brokers that are bridged together (e.g., message broker 112 and message broker 132 in the illustrative arrangement shown in FIG. 1) may use data store 120 by performing a write of any publishing message that is marked to be retained. Because of consistency mechanisms of data store 120 (e.g., a last-write-wins pattern), data store 120 may contain the most recent retained message for a topic. In some implementations, a TTL may also be implemented on messages in the store that specified a TTL. For such messages with expired TTLs, the messages may be automatically purged or otherwise removed from data store 120. For instance, if a client subscribes to a topic filter in which the most recent retained message for a topic included in the topic filter has an expired TTL, the message broker would not provide the client with this retained message due its expiration.

Together with storing retained messages in data store 120, each message broker in the set of bridged message brokers (e.g., message broker 112 and message broker 132) may also be configured to build and share a data structure (e.g., data structure 108 and data structure 128) that comprises topics that contain retained messages that the message broker has published. Various types of data structures may be used for this purpose, including but not limited to Tries, HashMaps and Graphs (or combinations thereof). In other words, each message broker will generate and continuously update its own corresponding data structure that indicates which topics have a retained message published by that broker. The data structures may also comprise retrieval information indicating how a retained message (or a set of retained messages) for a given topic may be obtained from data store 120, such as with a pointer, an identification of a row in a database, or any other suitable means. These per-broker data structures will be shared and/or synchronized to each of the other brokers in the set of merged message brokers such that the data structures collectively will indicate which topics have retained messages across the set of brokers. Where topic wildcards are present in a topic filter, these data structures may be used to identify and locate the most recent retained message corresponding to the topic wildcards (e.g., using a prefix matching algorithm or other suitable techniques), rather than using a direct data store read of data store 120. In other words, because the data structure may identify how to locate the relevant messages from data store 120, a comprehensive search of data store 120 can be avoided when a client subscribes to a new topic filter, thereby preserving system resources.

In implementations, when a client couples to one of the bridged message brokers and subscribes to one or more topic filters (which may contain a wildcard) and the message broker receives an indication of the new subscription, the message broker coupled to the client will access each of the individual broker-sourced data structures described herein to determine which relevant topic(s) have any retained messages. Stated differently, the message broker may access the data structure shared by each other message broker to identify one or more retained messages published by other brokers for topics associated with the topic filter. The message broker may also access the shared data structure to obtain retrieval information indicative of how the retained messages may be obtained or retrieved from data store 120. As disclosed above, data store 120 may be configured to have the most recent copy of the retained message. Because of this, data store 120 may contain the most recent message for a topic irrespective of which message broker may have published messages on the topic. The broker may then access data store 120 to retrieve any retained messages matching the client's subscriptions based on the information obtained from the data structures and provide those retained messages to the client.

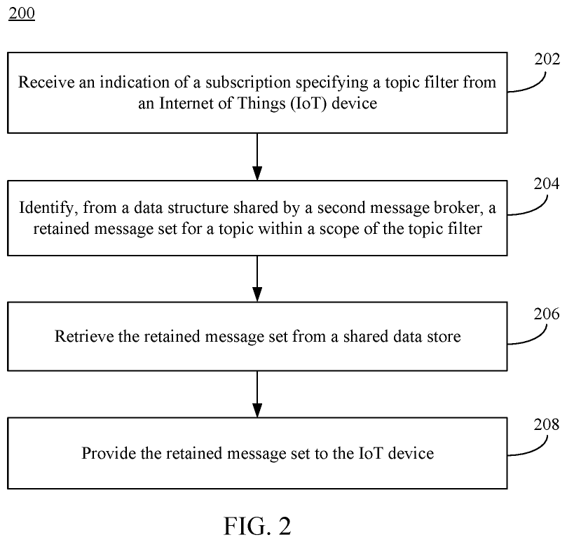

Handling retained messages across message brokers in system 100 may be carried out in various ways. For instance, retained messages may be identified and distributed according to FIG. 2. FIG. 2 shows a flowchart 200 of a method for handling retained messages among message brokers, in accordance with an example embodiment. In an implementation, the method of flowchart 200 may be implemented by retained message coordinator 106 and/or retained message coordinator 126. FIG. 2 is described with continued reference to FIG. 1. Other structural and operational implementations will be apparent to persons skilled in the relevant art(s) based on the following discussion regarding flowchart 200 and system 100 of FIG. 1. While example embodiments are described with respect to components of system 100 and flowchart 200, these examples are illustrative.

Flowchart 200 begins with step 202. In step 202, an indication of a subscription specifying a topic filter is received from an IoT device. For instance, with reference to FIG. 1, retained message coordinator 106 may receive an indication of a subscription specifying a topic filter from client 102. The subscription may include, for instance, one or more topic filters (which may contain one or more wildcard characters) for which client 102 seeks to receive messages, The subscription may be a new subscription that is initiated by client 102 (e.g., a subscription that was not previously active or registered). The subscription may be received in various ways, such as by a packet, message, or any other communication from client 102 to message broker 112 indicating information related to the new subscription.

In step 204, a retained message set for a topic within a scope of the topic filter is identified from a data structure shared by a second message broker. For instance, with reference to FIG. 1, retained message coordinator 106 may be configured to identify a retained message set for a topic within the scope of the topic filter contained in the subscription from client 102 from data structure 128 received from message broker 132. As described above, the data structure received from message broker 132 may comprise a listing of topics for which message broker 132 has published a retained message. Retained message coordinator 106 may access the data structure shared by message broker 132 to identify one or more topics within the scope of the subscription's topic filters (e.g., using a matching algorithm). Such identification may enable retained message coordinator 106 to determine which topics, if any, published by message broker 132 contain retained messages that fall within the scope of the client's subscriptions. In other words, using the shared data structure, retained message coordinator 106 may determine whether message broker 132 has published one or more retained messages falling within the scope of client 102's subscriptions.

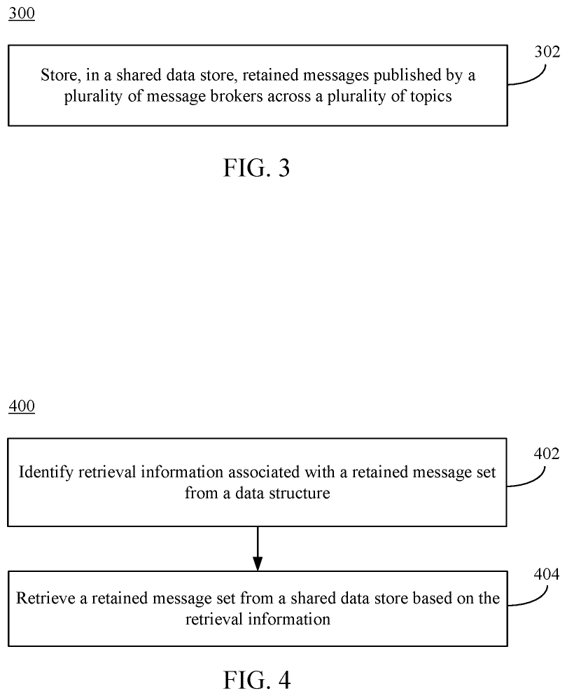

In step 206, the retained message set is retrieved from a shared data store. For instance, with reference to FIG. 3, retained message coordinator 106 may be configured to retrieve 150 the retained message set identified from the shared data structure from shared data store 120. As discussed above, shared data store 120 may comprise a storage or repository of retained messages that may be accessed by one or more message brokers to retrieve relevant messages for providing to clients. In example embodiments, shared data store 120 supports a last-write-wins pattern, in which a last (e.g., more recent) write overwrites previously stored data, such that data is retained in an up-to-date fashion. In implementations, data store 120 may support one or more other mechanisms to ensure or guarantee strong consistency on read requests.

In step 208, the retained message set is provided to the IoT device. For instance, with reference to FIG. 1, retained message coordinator may be configured to provide, via message broker 112, the retained message set retrieved from data store 120 to client 102. The retained message set may comprise one message or a plurality of messages (e.g., a plurality of retained messages for a given topic, or a plurality of retained messages across a multiple topics that fall within the scope of the client's subscription).

As discussed above, retained messages published by message brokers may be stored in various ways. For instance, FIG. 3 shows a flowchart 300 of a method for storing retained messages in a shared data store, in accordance with an example embodiment. In an implementation, the method of flowchart 300 may be implemented by retained message coordinator 106 and/or retained message coordinator 126. FIG. 3 is described with continued reference to FIG. 1. Other structural and operational implementations will be apparent to persons skilled in the relevant art(s) based on the following discussion regarding flowchart 300 and system 100 of FIG. 1.

Flowchart 300 begins with step 302. In step 302, retained messages published by a plurality of message brokers across a plurality of topics are stored in a shared data store. For instance, with reference to FIG. 1, retained message coordinator 106 and/or retrained message coordinator 126 (or any additional retained message coordinators not expressly shown) may be configured to store retained messages in shared data store 120 that is accessible by each message brokers in a set of bridged message brokers. Data store 120 may be a single storage device that is shared between the various message brokers, or may comprise a collection of storage devices (e.g., a storage in the cloud). Upon receiving a published message that is marked for retaining, a message broker may store such a message in shared data store 120 along with an indication in that message broker's shared data structure identifying the topic associated with the retained message and/or any information that may be used to retrieve the retained message from shared data store by one or more other brokers. If the same or a different message broker subsequently receives a message from a client for the same topic that is also marked for retaining, the message broker would similarly store the retained message in shared data store (which, due to the last-write-wins pattern, will overwrite the previously retained message on the topic) and update their shared data structure accordingly. Such techniques may be performed for any number of message brokers across any number of messages or topics.

Retained message coordinator 106 and/or retained message coordinator 126 may be configured to retrieve a set of retained messages in various ways. For instance, FIG. 4 shows a flowchart 400 of a method for retrieving a retained message set from a shared data store, in accordance with an example embodiment. In an implementation, the method of flowchart 400 may be implemented by retained message coordinator 106 and/or retained message coordinator 126. FIG. 4 is described with continued reference to FIG. 1. Other structural and operational implementations will be apparent to persons skilled in the relevant art(s) based on the following discussion regarding flowchart 400 and system 100 of FIG. 1.

Flowchart 400 begins with step 402. In step 402, retrieval information associated with a retained message set is identified from a data structure. For instance, with reference to FIG. 1, retained message coordinator 106 may be configured to identify retrieval information associated with a retained message set from a data structure shared by message broker 132. For instance, the shared data structure may indicate information relating to how a retained message (or a set of retained messages) for a given topic may be retrieved from data store 120, such as by identifying a pointer, a row in a database, or any identifying information associated with the storage of the corresponding retained message in data store 120. In examples, retained message coordinator 106 may access the data structure to identify such retrieval information along with identifying the set of retained messages for a given topic.

In step 404, the retained message set is retrieved from a shared data store based on the retrieval information. For instance, with reference to FIG. 1, retained message coordinator 106 may be configured to use the retrieval information identified from the shared data structure to retrieve the retained messages from data store 120. Upon retrieving the messages, message broker 112 may transmit the retained messages to client 102.

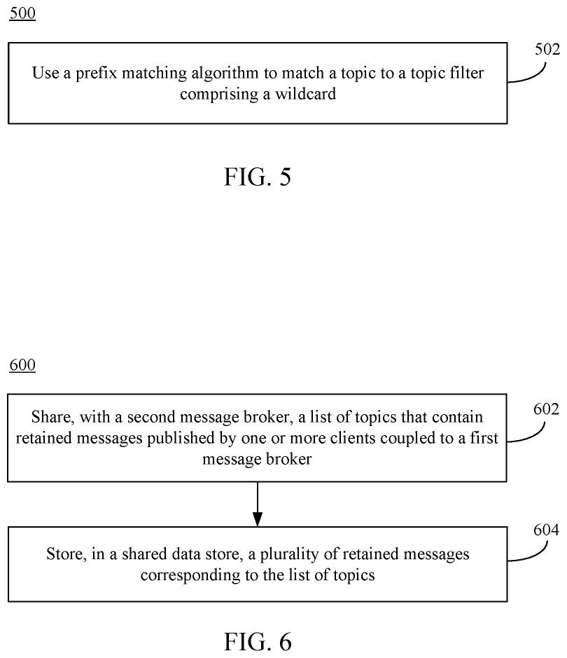

As discussed above, a data structure may be searched to identify topic that match a subscription's topic filters. For instance, FIG. 5 shows a flowchart 500 of a method for matching a topic to a topic filter, in accordance with an example embodiment. In an implementation, the method of flowchart 500 may be implemented by retained message coordinator 106 and/or retained message coordinator 126. FIG. 5 is described with continued reference to FIG. 1. Other structural and operational implementations will be apparent to persons skilled in the relevant art(s) based on the following discussion regarding flowchart 500 and system 100 of FIG. 1.

Flowchart 500 begins with step 502. In step 502, a prefix matching algorithm is used to match a topic to a topic filter comprising a wildcard. For instance, with reference to FIG. 1, the client's subscription may specify a topic filter that comprises one or more topic wildcards (e.g., wildcard characters), such as a single segment wildcard or a full topic wildcard. Because such topic filters may potentially encompass a plurality of matching topics retained message coordinator 106 may be configured to utilize one more searching algorithms, such as a prefix matching algorithm, to identify topics in the data structure that match the topic filter of the subscription. Such algorithms may enable retained message coordinator 106 to perform a search of the data structure based on a portion of the topic filter (e.g., a prefix) to reduce the search space and/or identify topics that have retained messages that match the topic filter.

As described above, retained messages may be shared with another message broker in various ways. For instance, FIG. 6 shows a flowchart 600 of a method for sharing a list of topics that contain retained messages with another message broker, in accordance with an example embodiment. In an implementation, the method of flowchart 600 may be implemented by retained message coordinator 106 and/or retained message coordinator 126. FIG. 6 is described with continued reference to FIG. 1. Other structural and operational implementations will be apparent to persons skilled in the relevant art(s) based on the following discussion regarding flowchart 600 and system 100 of FIG. 1.

Flowchart 600 begins with step 602. In step 602, a list of topics that contain retained messages published by one or more clients coupled to a first message broker is shared with a second message broker. For instance, with reference to FIG. 1, retained message coordinator 106 may receive message 104 from client 102 for publication that is marked for retaining. Upon receiving message 104 marked for retaining, retained message coordinator 106 may identify the topic associated with message 104, and store an indication that the associated topic contains a retained message in data structure 108 associated with message broker 112. The data structure associated with message broker 112 may be shared with one or more other message brokers (e.g., message broker 132) such that the topic associated with message 104 contains a retained message. Such techniques may be performed for each of a plurality of messages received by message broker 112 that are marked for retaining, resulting in retained message coordinator 106 storing and sharing a data structure containing a list of topics that contain retained messages published by one or more clients coupled to message broker 112

In step 604, a plurality of retained messages corresponding to the list of topics is stored in the shared data store. For instance, with reference to FIG. 1, retained message coordinator 106 may be configured to store a plurality of retained messages corresponding to the list of topics in shared data store 120. As discussed above, such messages may be stored in shared data store 120 such that other message brokers may retrieve relevant retained messages for a given topic, based on retrieval information provided in message broker 112's shared data structure. In this manner, messages received by message broker 112 that are marked for retaining may be stored in a manner such that one or more other messages brokers may efficiently identify and retrieve those messages for providing to clients.

### III. Example Computer System Implementation

Client 102, retained message coordinator 106, message broker 112, other publishing sources 114, event hub 116, computing device 118, data store 120, client 122, retained message coordinator 126, message broker 132, flowchart 200, flowchart 300, flowchart 400, flowchart 500, and/or flowchart 600 may be implemented in hardware, or hardware combined with one or both of software and/or firmware. For example, client 102, retained message coordinator 106, message broker 112, other publishing sources 114, event hub 116, computing device 118, data store 120, client 122, retained message coordinator 126, message broker 132, flowchart 200, flowchart 300, flowchart 400, flowchart 500, and/or flowchart 600 may be implemented as computer program code/instructions configured to be executed in one or more processors and stored in a computer readable storage medium.

Alternatively, client 102, retained message coordinator 106, message broker 112, other publishing sources 114, event hub 116, computing device 118, data store 120, client 122, retained message coordinator 126, message broker 132, flowchart 200, flowchart 300, flowchart 400, flowchart 500, and/or flowchart 600 may be implemented as hardware logic/electrical circuitry.

For instance, in an embodiment, one or more, in any combination, of client 102, retained message coordinator 106, message broker 112, other publishing sources 114, event hub 116, computing device 118, data store 120, client 122, retained message coordinator 126, message broker 132, flowchart 200, flowchart 300, flowchart 400, flowchart 500, and/or flowchart 600 may be implemented together in a system on a chip (SoC). The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

FIG. 7 depicts an exemplary implementation of a computing device 700 in which embodiments may be implemented. For example, client 102, retained message coordinator 106, message broker 112, other publishing sources 114, event hub 116, computing device 118, data store 120, client 122, retained message coordinator 126, message broker 132, flowchart 200, flowchart 300, flowchart 400, flowchart 500, and/or flowchart 600 (and/or any of the steps of flowcharts 200, 300, 400, 500, and/or 600) may be implemented in one or more computing devices similar to computing device 700 in stationary or mobile computer embodiments, including one or more features of computing device 700 and/or alternative features. The description of computing device 700 provided herein is provided for purposes of illustration, and is not intended to be limiting. Embodiments may be implemented in further types of computer systems, as would be known to persons skilled in the relevant art(s).

As shown in FIG. 7, computing device 700 includes one or more processors, referred to as processor circuit 702, a hardware accelerator 703, a system memory 704, and a bus 706 that couples various system components including system memory 704 to processor circuit 702 and hardware accelerator 703. Processor circuit 702 and/or hardware accelerator 703 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 702 may execute program code stored in a computer readable medium, such as program code of operating system 730, application programs 732, other programs 734, etc. Bus 706 represents one or more of any of several types of bus structures, including a memory bus or memory controller, a peripheral bus, an accelerated graphics port, and a processor or local bus using any of a variety of bus architectures. System memory 704 includes read only memory (ROM) 708 and random-access memory (RAM) 710. A basic input/output system 712 (BIOS) is stored in ROM 708.

Computing device 700 also has one or more of the following drives: a hard disk drive 714 for reading from and writing to a hard disk, a magnetic disk drive 716 for reading from or writing to a removable magnetic disk 718, and an optical disk drive 720 for reading from or writing to a removable optical disk 722 such as a CD ROM, DVD ROM, or other optical media. Hard disk drive 714, magnetic disk drive 716, and optical disk drive 720 are connected to bus 706 by a hard disk drive interface 724, a magnetic disk drive interface 726, and an optical drive interface 728, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 730, one or more application programs 732, other programs 734, and program data 736. Application programs 732 or other programs 734 may include, for example, computer program logic (e.g., computer program code or instructions) for implementing any of the features of client 102, retained message coordinator 106, message broker 112, other publishing sources 114, event hub 116, computing device 118, data store 120, client 122, retained message coordinator 126, message broker 132, flowchart 200, flowchart 300, flowchart 400, flowchart 500, and/or flowchart 600 and/or further embodiments described herein.

A user may enter commands and information into computing device 700 through input devices such as keyboard 738 and pointing device 740. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 702 through a serial port interface 742 that is coupled to bus 706, but may be connected by other interfaces, such as a parallel port, game port, or a universal serial bus (USB).

A display screen 744 is also connected to bus 706 via an interface, such as a video adapter 746. Display screen 744 may be external to or incorporated in computing device 700. Display screen 744 may display information, as well as being a user interface for receiving user commands and/or other information (e.g., by touch, finger gestures, virtual keyboard, etc.). In addition to display screen 744, computing device 700 may include other peripheral output devices (not shown) such as speakers and printers.

Computing device 700 is connected to a network 748 (e.g., the Internet) through an adaptor or network interface 750, a modem 752, or other means for establishing communications over the network. Modem 752, which may be internal or external, may be connected to bus 706 via serial port interface 742, as shown in FIG. 7, or may be connected to bus 706 using another interface type, including a parallel interface.

As used herein, the terms “computer program medium,” “computer-readable medium,” and “computer-readable storage medium” are used to refer to physical hardware media such as the hard disk associated with hard disk drive 714, removable magnetic disk 718, removable optical disk 722, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with propagating signals and communication media (do not include propagating signals and communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 732 and other programs 734) may be stored on the hard disk, magnetic disk, optical disk, ROM, RAM, or other hardware storage medium. Such computer programs may also be received via network interface 750, serial port interface 742, or any other interface type. Such computer programs, when executed or loaded by an application, enable computing device 700 to implement features of embodiments discussed herein. Accordingly, such computer programs represent controllers of the computing device 700.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Further Example Embodiments

A system for handling retained messages among brokers of IoT messages is disclosed herein. The system includes: at least one processor circuit; and at least one memory that stores program code configured to be executed by the at least one processor circuit, the program code comprising: a retained message coordinator of a first message broker configured to: receive an indication of a subscription specifying a topic filter from an IoT device; identify, from a data structure shared by a second message broker, a retained message set for a topic within a scope of the topic filter; retrieve the retained message set from a shared data store; and provide the retained message set to the IoT device.

In one implementation of the foregoing system, the retained message set comprises at least one most recent message published to the topic by a client coupled to the second message broker.

In another implementation of the foregoing system, the shared data store comprises a storage that stores retained messages published by a plurality of message brokers across a plurality of topics.

In another implementation of the foregoing system, the shared data store supports a last-write-wins pattern.

In another implementation of the foregoing system, the retained message coordinator, to retrieve the retained message set, is configured to: identify retrieval information associated with the retained message set from the data structure; and retrieve the retained message set from the shared data store based on the retrieval information.

In another implementation of the foregoing system, the subscription specifying the topic filter comprises a topic wildcard, and the retained message coordinator is configured to use a prefix matching algorithm to match the topic to the topic filter comprising the wildcard.

In another implementation of the foregoing system, the retained message coordinator is configured to: share, with the second message broker, a list of topics that contain retained messages published by one or more clients coupled to the first message broker, and store, in the shared data store, a plurality of retained messages corresponding to the list of topics.

A method for handling retained messages among brokers of IoT messages is disclosed herein. The method includes: receiving, in a first message broker, an indication of a subscription specifying a topic filter from an IoT device; identifying, from a data structure shared by a second message broker, a retained message set for a topic within a scope of the topic filter; retrieving the retained message set from a shared data store; and providing the retained message set to the IoT device.

In one implementation of the foregoing method, the retained message set comprises at least one most recent message published to the topic by a client coupled to the second message broker.

In another implementation of the foregoing method, the shared data store comprises a storage that stores retained messages published by a plurality of message brokers across a plurality of topics.

In another implementation of the foregoing method, the shared data store supports a last-write-wins pattern.

In another implementation of the foregoing method, the retrieving the retained message set comprises: identifying retrieval information associated with the retained message set from the data structure; and retrieving the retained message set from the shared data store based on the retrieval information.

In another implementation of the foregoing method, the subscription specifying the topic filter comprises a topic wildcard, and the method further comprises using a prefix matching algorithm to match the topic to the topic filter comprising the wildcard.

In another implementation of the foregoing method, the method further comprises sharing, with the second message broker, a list of topics that contain retained messages published by one or more clients coupled to the first message broker, and storing, in the shared data store, a plurality of retained messages corresponding to the list of topics.

A computer-readable storage is disclosed herein. The computer-readable storage medium has program instructions recorded thereon that, when executed by at least one processor of a computing device, perform a method, the method comprising: receiving, in a first message broker, an indication of a subscription specifying a topic filter from an IoT device; identifying, from a data structure shared by a second message broker, a retained message set for a topic within a scope of the topic filter; retrieving the retained message set from a shared data store; and providing the retained message set to the IoT device.

In one implementation of the foregoing computer-readable storage medium, the retained message set comprises at least one most recent message published to the topic by a client coupled to the second message broker.

In one implementation of the foregoing computer-readable storage medium, the shared data store comprises a storage that stores retained messages published by a plurality of message brokers across a plurality of topics.

In one implementation of the foregoing computer-readable storage medium, the shared data store supports a last-write-wins pattern.

In one implementation of the foregoing computer-readable storage medium, the retrieving the retained message set comprises: identifying retrieval information associated with the retained message set from the data structure; and retrieving the retained message set from the shared data store based on the retrieval information.

In one implementation of the foregoing computer-readable storage medium, the method further comprises: sharing, with the second message broker, a list of topics that contain retained messages published by one or more clients coupled to the first message broker, and storing, in the shared data store, a plurality of retained messages corresponding to the list of topics.

### V. Conclusion

While various embodiments have been described above, it should be understood that they have been presented by way of example only, and not limitation. It will be understood by those skilled in the relevant art(s) that various changes in form and details may be made therein without departing from the spirit and scope of the described embodiments as defined in the appended claims. Accordingly, the breadth and scope of the present embodiments should not be limited by any of the above-described exemplary embodiments, but should be defined only in accordance with the following claims and their equivalents.

1. A system for handling retained messages among brokers of Internet of Things (IoT) messages, comprising:
a processor circuit; and
a memory that stores program code configured to be executed by the processor circuit, the program code comprising:
a retained message coordinator of a first message broker configured to:
identify a first topic that contains a first retained message set published by one or more clients coupled to the first message broker;
share the first topic with a second message broker via a data structure shared with the second message broker;
store, in a data store that is shared with the second message broker, the first retained message set;
receive an indication of a subscription specifying a topic filter from an IoT device;
identify, from the data structure shared with the second message broker, a second retained message set for a second topic within a scope of the topic filter;
retrieve the second retained message set from the data store; and
provide the second retained message set to the IoT device.

2. The system of claim 1, wherein the second retained message set comprises at least one most recent message published to the second topic by a client coupled to the second message broker.

3. The system of claim 1, wherein the data store comprises a storage that stores retained messages published by a plurality of message brokers across a plurality of topics.

4. The system of claim 3, wherein the data store supports a last-write-wins pattern.

5. The system of claim 1, wherein the retained message coordinator is configured to retrieve the second retained message set, by:
identifying retrieval information associated with the second retained message set from the data structure; and
retrieve the second retained message set from the data store based on the retrieval information.

6. The system of claim 1, wherein,
the subscription specifying the topic filter comprises a topic wildcard, and
the retained message coordinator is configured to use a prefix matching algorithm to match the topic to the topic filter comprising the wildcard.

7. (canceled)

8. A method for handling retained messages among brokers of Internet of Things (IoT) messages, comprising:
identifying a first topic that contains a first retained message set published by one or more clients coupled to a first message broker;
sharing the first topic with a second message broker via a data structure shared with the second message broker;
storing, in a data store that is shared with the second message broker, the first retained message set;
receiving an indication of a subscription specifying a topic filter from an IoT device;
identifying, from the data structure shared with the second message broker, a second retained message set for a second topic within a scope of the topic filter;
retrieving the second retained message set from the data store; and
providing the second retained message set to the IoT device.

9. The method of claim 8, wherein the second retained message set comprises at least one most recent message published to the second topic by a client coupled to the second message broker.

10. The method of claim 8, wherein the data store comprises a storage that stores retained messages published by a plurality of message brokers across a plurality of topics.

11. The method of claim 10, wherein the data store supports a last-write-wins pattern.

12. The method of claim 8, wherein the retrieving the second retained message set comprises:
identifying retrieval information associated with the second retained message set from the data structure; and
retrieving the second retained message set from the data store based on the retrieval information.

13. The method of claim 8, wherein,
the subscription specifying the topic filter comprises a topic wildcard, and
the method further comprises using a prefix matching algorithm to match the topic to the topic filter comprising the wildcard.

14. (canceled)

15. A computer-readable storage medium having program instructions recorded thereon that, when executed by a processor of a computing device, perform a operations comprising:
identifying a first topic that contains a first retained message set published by one or more clients coupled to a first message broker;
sharing the first topic with a second message broker via a data structure shared with the second message broker;
storing, in a data store that is shared with the second message broker, the first retained message set;
receiving an indication of a subscription specifying a topic filter from an IoT device;
identifying, from the data structure shared with the second message broker, a second retained message set for a second topic within a scope of the topic filter;
retrieving the second retained message set from the data store; and
providing the second retained message set to the IoT device.

16. The computer-readable storage medium of claim 15, wherein the second retained message set comprises at least one most recent message published to the second topic by a client coupled to the second message broker.

17. The computer-readable storage medium of claim 15, wherein the data store comprises a storage that stores retained messages published by a plurality of message brokers across a plurality of topics.

18. The computer-readable storage medium of claim 17, wherein the data store supports a last-write-wins pattern.

19. The computer-readable storage medium of claim 15, wherein the retrieving the second retained message set comprises:
identifying retrieval information associated with the second retained message set from the data structure; and
retrieving the second retained message set from the data store based on the retrieval information.

20. (canceled)

21. The computer-readable storage medium of claim 15, wherein,
the subscription specifying the topic filter comprises a topic wildcard, and
the operations further comprise using a prefix matching algorithm to match the topic to the topic filter comprising the wildcard.
